(19) United States
(12) Patent Application Publication
(10) Pub. No.: US 2025/0174689 A1
(43) Pub. Date: May 29, 2025

(54) HYDROGEN CONSUMPTION SYSTEM

(71) Applicant: TOYOTA JIDOSHA KABUSHIKI KAISHA, Toyota-shi (JP)

(72) Inventors: Yoshikatsu FUJIMURA, Toyota-shi (JP); Keiichi KANEKO, Mishima-shi (JP); Naoki TOMI, Kawasaki-shi (JP); Tetsuya TONOSAKO, Susono-shi (JP); Tomoki NAKASHIMA, Nagoya-shi (JP); Koji SUGIURA, Toyota-shi (JP); Kei KATO, Nagakute-shi (JP)

(21) Appl. No.: 18/901,272

(22) Filed: Sep. 30, 2024

(30) Foreign Application Priority Data
Nov. 28, 2023 (JP) 2023-200704

(51) Int. Cl. H01M 8/04746; F17C 7/00; F17C 13/02; H01M 8/04082; H01M 8/0438; H01M 8/04537; H01M 8/04955

(52) U.S. Cl. CPC H01M 8/04753; F17C 7/00; F17C 13/02; H01M 8/04201; H01M 8/04388; H01M 8/04582; H01M 8/04955; F17C 2201/0109; F17C 2203/012; F17C 2203/0604; F17C 2203/0619; F17C 2203/0673; F17C 2205/0323; F17C 2205/0352; F17C 2221/012; F17C 2250/0426; F17C 2250/043; F17C 2250/0694; F17C 2270/0184

(57) ABSTRACT

To provide a hydrogen consumption system capable of suppressing the generation of emission sound at the time of separation of a hydrogen tank, which is unlikely to cause defects. Detachable hydrogen tank, a fuel cell using hydrogen from the hydrogen tank as a fuel, connecting the hydrogen tank and the fuel cell, a pipe through which hydrogen flows, the opening and closing valve provided in the pipe, and a control device, when desorption of the hydrogen tank, the control device closes the on-off valve, the pressure in the pipe to calculate the amount of hydrogen consumed by the power generation of the fuel cell until less than 1 MPa, the current demand value of the fuel cell from the amount of hydrogen consumed, and, the current upper limit value of the fuel cell is calculated, when the actual current value is greater than the current upper limit value, the current request value performs control for changing to be equal to or less than the current upper limit value.

### FIELD

The present disclosure relates to hydrogen consumption systems.

### BACKGROUND

Patent Document 1 discloses a fuel gas consumption system and a method of detecting gas leakage of a fuel gas consumption system, which can shorten a time until a system shutdown and quickly determine a leakage. Here, in order to depressurize the hydrogen of the high-pressure piping, the consumption of fuel gas by power generation or the hydrogen of the high-pressure piping by exhausting from the hydrogen pipe downstream (exhaust drain valve) is carried out depressurization.

### CITATION LIST

### Patent Literature

Patent Literature 1: JP 2007-121210 A

### SUMMARY

### Technical Problem

When the hydrogen tank (hydrogen cartridge tank) is detached from the hydrogen consumption system, sound (emission sound) is generated if high-pressure hydrogen remains in the piping at the desorption part between the hydrogen tank and the piping. Even if the amount of hydrogen is small, the emission sound when a few 10 MPa of hydrogen pressure remains gives a great sense of discomfort to the user. In order to solve this problem, it is necessary to reduce the hydrogen pressure of the piping of the desorption part to the specified value when the hydrogen tank is detached.

However, in the prior art, it has not been possible to sufficiently reduce the pressure until the generation of the emission sound can be suppressed. On the other hand, if it is sufficient to reduce the pressure, hydrogen can be released inevitably, resulting in fuel waste and hydrogen shortage in the fuel cell. In view of the above problems in the present disclosure, it is an object of the present disclosure to provide a hydrogen consumption system capable of suppressing the generation of a discharge sound which hardly causes a defect at the time of leaving a hydrogen tank.

### Solution to Problem

The present application discloses a hydrogen consumption system comprising: a desorbable hydrogen tank; a fuel cell using hydrogen from the hydrogen tank as a fuel; connecting the hydrogen tank and the fuel cell; a pipe through which hydrogen flows; an on-off valve provided in the pipe; and a control device, wherein when the hydrogen tank is detached, the control device closes the on-off valve and calculates the amount of hydrogen consumed by the power generation of the fuel cell until the pressure in the pipe becomes less than 1 MPa; a current required value of the fuel cell from the amount of hydrogen consumed; and a current upper limit value of the fuel cell is calculated; and when the actual current value is greater than the current upper limit value, the control is performed to change the current required value to be equal to or less than the current upper limit value.

The controller may contrast the estimated pressure at which hydrogen depletion occurs in the fuel cell with the actual pressure in the piping to perform control to stop power generation by the fuel cell when the actual pressure is equal to or less than the estimated pressure.

### Advantageous Effects

According to the present disclosure, when desorption of the hydrogen tank, since the depressurization in the pipe while controlling the hydrogen remaining in the pipe, while continuing the power supply by the power generation of the fuel cell, the fuel (hydrogen) it is possible to suppress the emission sound on suppressing the waste and shortage.

### BRIEF DESCRIPTION OF DRAWINGS

FIG. 1 is a diagram showing the configuration of a hydrogen consumption system 10.

FIG. 2A is an appearance of the hydrogen tank 11, FIG. 2B is a diagram showing a cross section of the hydrogen tank 11.

FIG. 3 is a diagram for explaining the on-off valve 15 and the connecting device 23.

FIG. 4 is a diagram illustrating a control device 50.

FIG. 5 is a diagram illustrating the flow of the tank separation control S10.

### DESCRIPTION OF EMBODIMENTS

### 1. Hydrogen Consumption System

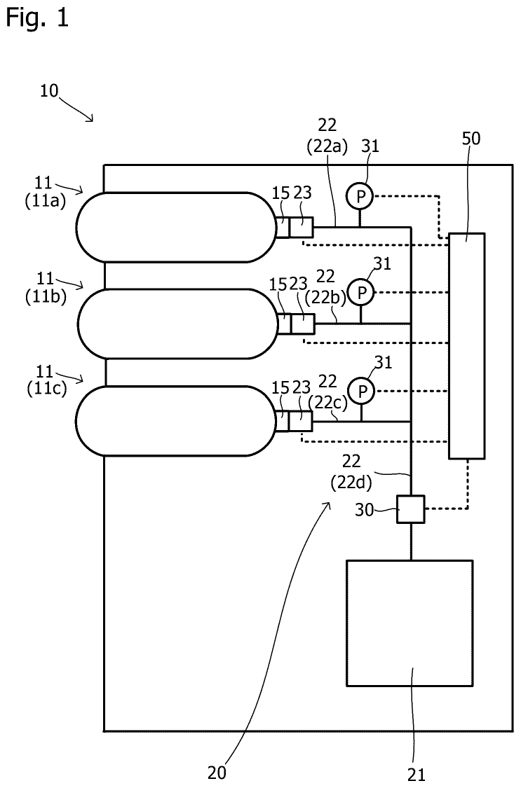

FIG. 1 conceptually shows the configuration of the hydrogen consumption system 10 according to one form. Such a hydrogen consumption system 10 has a hydrogen tank 11 which is a source of hydrogen, a consumption device 20 which is a supply destination of the hydrogen, and a control device 50 Hydrogen consumption system 10 of the present embodiment is a system for generating electricity by supplying hydrogen stored in the hydrogen tank 11 to the fuel cell 21 included in the consumption device 20. In addition, in the present embodiment, the hydrogen tank 11 is configured to be able to be attached to and detached from the consuming device 20

It will be described in more detail below for.

### 1.1. Hydrogen Tank

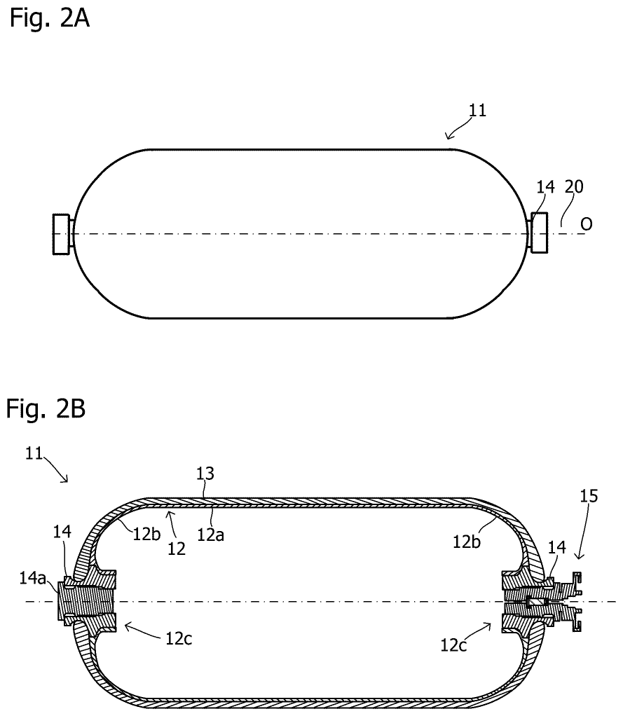

The hydrogen tank 11 is a container in which fuel to be supplied (hydrogen in this form) is stored in a liquid state or a gaseous state. FIGS. 2A and 2B show diagrams for illustration.

FIG. 2A is an external view, FIG. 2B is a sectional view taken along the axial direction of the tank 11. As can be seen from these figures, the hydrogen tank 11 in this form has a liner 12, the reinforcing layer 13, the mouthpiece 14, and the on-off valve 15. Each configuration will be described below.

Although description thereof will be omitted, the hydrogen tank 11 may be provided with an exterior body or a handle in order to improve aesthetics and portability.

### 1.1.1. Liner

The liner 12 is a hollow member which partitions the internal space of the hydrogen tank 11, and is cylindrical in this form. Liner 12, the opening at both ends of the fuselage 12a diameter is substantially constant is narrowed by the dome-shaped side-end 12b, the cap 14 is disposed in the narrowed opening 12c.

It is sufficient that the liner 12 is made of a material capable of holding (hydrogen) contained in its internal space without leaking, and a known material can be used as the material. Specifically, for example, a nylon resin, a polyethylene-based synthetic resin, or made of a metal such as stainless steel or aluminum. Among them, it is preferable that the material constituting the liner is a synthetic resin from the viewpoint of weight reduction of the tank.

The thickness of the liner 12 is not particularly limited, but is preferably 0.5 mm˜3.0 mm.

### 1.1.2. Reinforcement Layer

In the reinforcing layer 13, fibers are laminated over a plurality of layers, and a cured resin is impregnated into the fibers. A layer made of fibers is formed by winding a fiber bundle over a plurality of layers to a predetermined thickness on an outer periphery of a liner 12

Although the thickness of the reinforcing layer 13 and the number of turns of the fiber bundle are determined by the required strength, they are not particularly limited, but are of a 10 mm˜30 mm degree.

<Fiber bundle>

For example, carbon fibers are used for the fiber bundle of the reinforcing layer 13, and the fiber bundle has a band shape in which carbon fibers form a bundle and have a predetermined cross-sectional shape (e.g., a rectangular cross section) Although not particularly limited, there may be mentioned a rectangular shape having a 6 mm-20 mm cross section and a 0.1 mm-0.3 mm thickness. The amount of carbon fibers contained in the fiber bundle is not particularly limited, and examples thereof include a carbon fiber of about 36000.

### <Impregnated Resin>

The resin impregnated and cured in the fiber (fiber bundle) in the reinforcing layer 13 is not particularly limited as long as it can increase the strength of the fiber by this. Examples thereof include a thermosetting resin which is cured by heat, and specific examples thereof include an amine-based or anhydride-based curing accelerator and an epoxy resin containing a rubber-based reinforcing agent, an unsaturated polyester resin, and the like. In addition, a resin composition containing an epoxy resin as a main agent and cured by mixing a curing agent thereto can be also mentioned. According to this, it is automatically cured by allowing the resin composition which is the mixture to reach and penetrate the fiber layer between the time when the main agent and the curing agent are mixed and cured.

### <Protective Layer>

If necessary, a protective layer may be disposed on an outer periphery of the reinforcing layer. When provided, for example, glass fibers are wound and impregnated with a resin. The resin to be impregnated can be considered similarly to the reinforcing layer 12 Thus it is possible to impart impact resistance to the tank 11.

Although there is no particular limitation on the thickness of the protective layer, it may be a 1.0 mm-1.5 mm degree.

1.1.3. mouthpiece

Mouthpiece 14 is a member which is attached to each of the two opening 12c of the liner 12, are arranged at each of the axial lines O of the liner 12, and functions as an opening communicating the inside and outside of the hydrogen tank 11, the on-off valve 15 is attached. Thus the mouthpiece 14, the cross section for the on-off valve 15 is disposed a circular hole is provided. The inner surface of the hole is provided with a female screw corresponding to the male screw of the on-off valve 15. The on-off valve 15 is fixed to the mouthpiece 14 by combining with the male screw of the on-off valve 15 to the female screw. Further, the inner surface of the hole has a sealing surface which is a smooth surface on the tank inside (high pressure side) than the female thread. The seal member provided on the outer periphery of the on-off valve 15 on the sealing surface is in contact with the inside of the hydrogen tank 11 airtight (seal) is made.

The member constituting the base 14 is not particularly limited as long as it has the necessary strength, and examples thereof include stainless steel and aluminum.

### 1.1.4. Open/Close Valve

The on-off valve 15 is held in the hole of the cap 14 of the hydrogen tank 11. The on-off valve 15 is disposed on one of two mouthpieces 14 provided at both longitudinal ends of the hydrogen tank 11. Incidentally, the mouthpiece 14 on the other side is sealed with a stopper 14a is disposed.

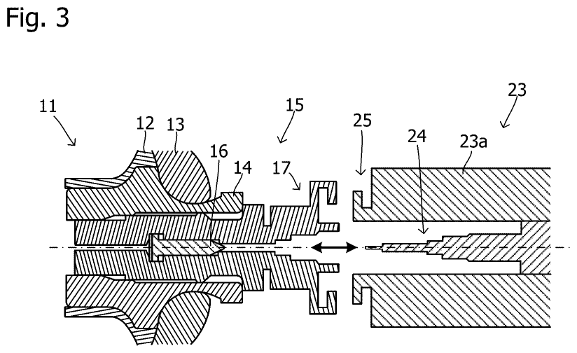

In FIG. 3 is a diagram including the vicinity of the on-off valve 15 of FIG. 2B, it represents a diagram of separating the connecting device 23 of the consumption device 20 to be described later on the on-off valve 15. The on-off valve 15 has a shaft portion disposed inside the hole of the mouthpiece 14 is provided with a male screw which is combined with the female screw of the mouthpiece 14 on the outer peripheral surface of the shaft portion, whereby the on-off valve 15 is fixed to the hole of the mouthpiece 14. Further, the outer peripheral surface of the on-off valve 15 is disposed a seal member (not shown), the seal member is disposed so as to contact the seal surface of the inner surface of the hole of the mouthpiece 14 airtight (seal) is made.

The on-off valve 15 has a valve body 16, and a connecting portion 17.

### <Valve Element>

The valve element 16 is a switching valve for permitting and regulating the communication of the inside and outside of the hydrogen tank 11. In this form, a check valve is applied as the valve element 16. Therefore, the valve body 16 in the present embodiment is biased so as to restrict the communication when closed valve, the valve body 16 by pressing against the urging valve body 16 is moved and the communication is allowed. Thus in this form to switch the communication by pressing and releasing the valve element 16, it is necessary means for pressing the valve element 16. Therefore, as will be described later in this form, a measures (push rod 24) for pressing the valve element 16 is provided in the consuming device 20 By performing the opening and closing of the valve body 16 as a check valve in the consumption device 20 side, it is not necessary to control by electrically connecting the hydrogen tank 11 to the control device 50 to be attached and detached, the control by the control device 50 can be performed more reliably.

Although the present embodiment in which a check valve is applied as the valve element 16 in this form has been described as described above, the present embodiment is not limited as long as the communication in and out of the hydrogen tank 11 can be allowed and restricted, and a solenoid valve can be applied to the valve element. It is possible to directly open and close control in the control device 50 without using a measures for pressing by using the solenoid valve.

### <Connection Part>

The on-off valve 15, the side connected to the consumption device 20 has a connecting portion 17 connected to the consumption device 20. In the connecting portion 17 is a portion capable of engagement and disengagement between the connecting portion 25 of the connecting portion 17 and the connecting device 23 of the consumption device 20. The specific aspect is not limited, but a mechanical coupling (mechanical interface) can be exemplified in the present embodiment, among which a mount such as connecting a photographing lens to the main body in the camera can be applied, and more specifically, it is possible to use the C mount.

### 1.1.5. Other

The allowable pressure of the hydrogen tank 11 is not particularly limited, but may include a tank capable of storing hydrogen at an allowable pressure of 70 mPa or less beyond 20 mPa from the viewpoint of supplying more hydrogen. In the present embodiment, it is possible to perform the separation of the appropriate tank for the tank of such a high pressure.

In this form, a plurality of hydrogen tanks 11 are provided (e.g., 3), and each hydrogen tank 11 is filled with hydrogen. Here, three hydrogen-tank 11 are arranged, and the sign is expressed in 11a, 11b, 11c in order to distinguish them. All of these hydrogen tanks 11 may have the same capacity, or tanks of different capacities may be included.

### 1.2. Consumption Device

The consuming device 20 is a supply destination of hydrogen from the hydrogen tank 11, and is a device which receives hydrogen and consumes it. Consumption device 20 in this form, as shown in FIG. 1, the fuel cell 21, the supply pipe 22, the connecting device 23, the injection 30, and a pressure gauge 31.

### 1.2.1. Fuel Cell

Fuel cell 21 is a device that consumes the supplied hydrogen, to generate electricity by receiving the supply of air from the air hole (not shown) with the supply of hydrogen from the hydrogen tank 11. A specific configuration of the fuel cell 21 is not particularly limited, and a known one can be used.

### 1.2.2. Feed Piping

Supply pipe 22 is a pipe forming a path for guiding hydrogen from the hydrogen tank 11 to the fuel cell 21. In this form, each of the hydrogen tank 11a, 11b, 11c and the fuel cell 21 is connected. Here, the pipe 22a, 22b, 22c extending from each of the hydrogen tank 11a, 11b, 11c is connected to the fuel cell 21 becomes one pipe 22d merges.

### 1.2.3. Connecting Device

Connecting device 23 is disposed at a connection portion between the hydrogen tank 11 of the supply pipe 22, with connected to the connecting portion 17 provided in the opening and closing valve 15 of the hydrogen tank 11 described above, the valve body 16 of the hydrogen tank 11 (check valve) to operate the opening and closing. In FIG. 3 is a diagram including the vicinity of the connecting device 23 of FIG. 2B, it shows a diagram of separating the connecting device 23 of the on-off valve 15 and the consumption device 20. Connecting device 23 as can be seen from FIG. 3 has a cylindrical body 23a, the push rod 24 disposed inside the cylindrical body 23a, a connecting portion 25 provided at the distal end of the cylindrical body 23a.

### <Push Rod>

The push rod 24 is a member capable of pressing the valve element 16 provided in the opening/closing valve 15 of the hydrogen tank 11, and is rod-shaped in the present embodiment, and can press the valve element 16 at its tip. Therefore, as can be seen from

FIG. 3, the push rod 24 is disposed on the inner side of the cylindrical body 23a, as shown by a straight arrow in FIG. 3 is configured to be able to project from the cylindrical body 23a to move in its axial direction.

And closing the supply pipe 22 when the push rod 24 is submerged, the supply pipe 22 when the push rod 24 is protruding is configured to be opened, the push rod 24 also serves as an on-off valve of the supply pipe 22 side.

The push rod 24 is controlled by the control device 50 for its immersion. However, the system configuration for opening and closing the supply pipe 22 controls and drives the hydrogen tank 11-on-off valve 15 side to fix the push rod side 24, it may be a structure for pressing the valve body 16.

### <Connection Part>

Connecting portion 25, of the cylindrical 23a, is provided at an end portion of the opposite to the connecting portion 17 provided on the on-off valve 15. The connecting portion 25 is adapted to be engaged and disengaged from the connecting portion 17 as described above. Specifically, a mechanical coupling (mechanical interface) can be cited in this form, and among them, a mount for connecting a photographing lens to a main body can be applied in a camera, and more specifically, a C-mount can be used.

### 1.2.4. Injection

Injection 30 is disposed in the supply pipe 22 between the connecting device 23 and the fuel cell 21 (supply pipe 22d in the present embodiment), to control the supply of hydrogen to the fuel cell 21. Although a specific form of injection is not particularly limited, a flow rate adjusting valve may be mentioned.

Incidentally, depending on the form of the injection 30, there is a case where a pressure regulating valve (pressure reducing valve) between the connecting device 23 and the injection 30.

### 1.2.5. Pressure Gauge

Pressure gauge 31 is a pressure gauge for measuring the flow path pressure of the supply flow path 22 (pressure in the pipe) between the connecting device 23 and the injection 30. Although there is no particular limitation on the specific form of the pressure gauge 31 in this embodiment, it is configured so that the obtained pressure value data can be transmitted to the control device 50.

### 1.3. Controller

Controller 50, when the desorption of the hydrogen tank 11, a control device for commanding to adjust the conditions of desorption of the hydrogen tank 11 by performing an operation. Therefore, the control device 50 in this form, the push rod 24 of the connecting device 23, the injection 30, is configured to be able to communicate with the pressure gauge 31.

On the other hand, for the opening and closing of the supply pipe 22, when the structure for pressing the valve body 16 by controlling and driving the hydrogen tank 11. on-off valve 15 side with the push rod side 24 is fixed, the push rod 24 to allow communication with the hydrogen tank 11·on-off valve 15 side rather than communication.

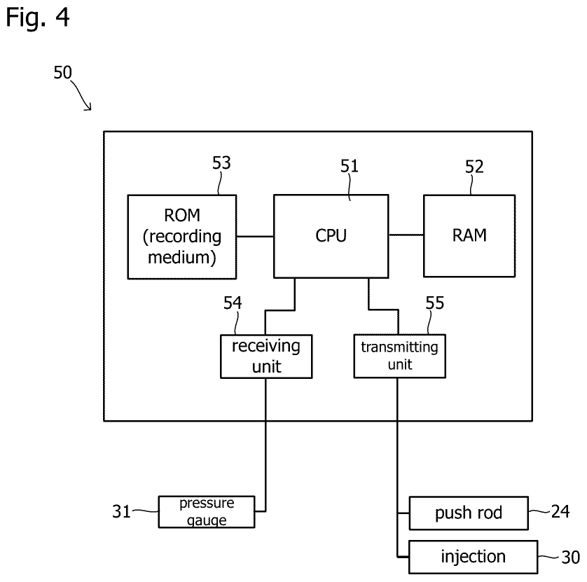

As conceptually illustrated in FIG. 4, the control unit 50 includes a CPU (Central Processing Unit that is a processor and performs operations, a central processing unit (CPU) 51, a RAM (Random Access Memory) 52 that functions as a working area, a ROM (Read-Only Memory) 53 that functions as a recording medium, a receiving unit 54 that is an interface that accepts information to the control unit 50 regardless of wired or wireless, and a transmitting unit 55 that is an interface that sends information to the outside from the control unit 50 regardless of wired or wireless.

Thus the control unit 50 receives the information is connected to the pressure gauge 31 to the receiving unit 54, the push rod 24 to the transmitting unit 55, the injection 30 is connected is configured to be able to transmit a signal for its operation to these. On the other hand, for the opening and closing of the supply pipe 22, when the structure for pressing the valve body 16 by controlling the hydrogen tank 11·on-off valve 15 side with the push rod side 24 fixed, the transmission unit 55 hydrogen tank 11·on-off valve 15 side rather than connecting the push rod 24 becomes a configuration for connecting.

The control unit 50, when the detachment of the hydrogen tank 11, a program for transmitting a signal for operation to each device and arithmetic processing for conditioning for the detachment is stored. In controller 50, CPU51, RAM52 and ROM53 as a hardware resource and the programme work together. Specifically, CPU51 performs the desired control by executing a computer program recorded in ROM53 in a RAM52 that functions as a workspace. The data acquired or generated by CPU51 is stored in RAM52. In addition, a recording medium may be separately provided inside or outside the control device 50, and a program and various data may be recorded therein. Specific control contents will be described later.

Such a control device 50 can typically be configured by a computer.

### 2. Tank Separation Control

It will be described control performed during the desorption of the hydrogen tank 11 in the hydrogen consumption system 10 below.

### 2.1. Hydrogen Supply Condition

Prior to desorption of the hydrogen tank 11, hydrogen flows out from the hydrogen tank 11, hydrogen is supplied to the fuel cell 21 through the supply pipe 22 is generated by the fuel cell 21. At this time, the hydrogen tank 11 is in a condition of being connected to the consumption device 20, and the on-off valve 15 and the push rod 24 is opened.

That is, the hydrogen tank 11 is mounted, when in the hydrogen supply condition, together with the connecting portion 25 provided in the connecting device 23 of the connecting portion 17 and the consuming device 20 provided on the opening and closing valve 15 of the hydrogen tank 11 is engaged, the push rod 24 protrudes from the cylindrical body 23a its distal end reaches the inside of the on-off valve 15 is pressing the valve body 16, the on-off valve 15 and the push rod 24 is in the open state.

In this case, the pressure in the supply pipe 22 is substantially the same as the internal pressure of the hydrogen tank 11, a high-pressure state.

### 2.2. Flow of Desorption of Hydrogen Tank

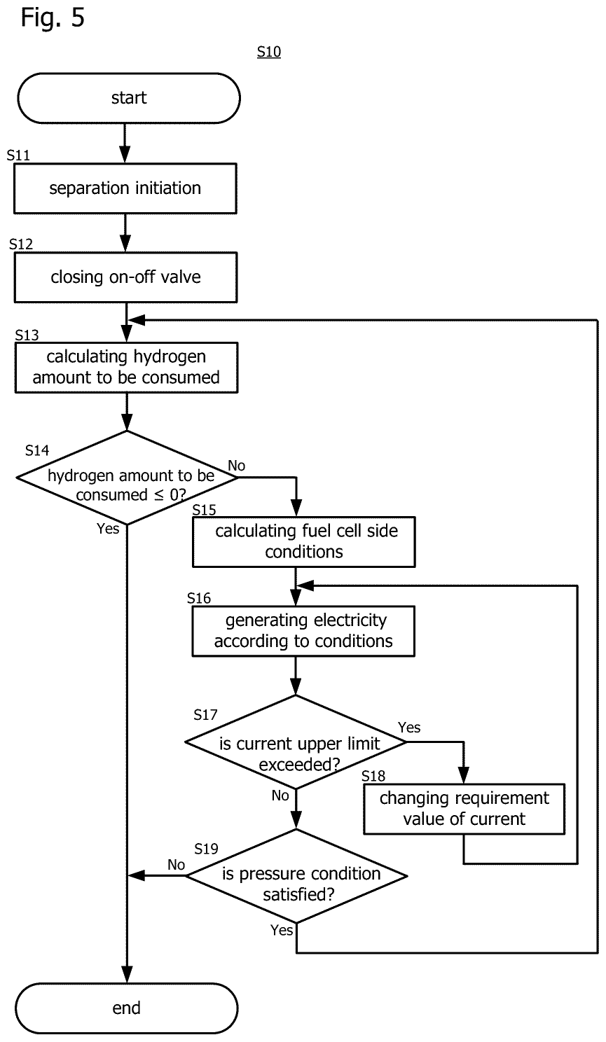

FIG. 5 shows the flow of the tank-separation control S10 according to one form. As can be seen in FIG. 5, the tank-leaving control S10 includes a process S11 to process S19. Each of these processes is advanced by a program stored in the control device 50, and the operation of each device is performed according to an instruction from the control device 50 Hereinafter, each process will be described.

### 2.2.1. Start of Withdrawal

In the process S11 of desorption initiation, the controller 50 receives a signal that triggers the onset of hydrogen-tank desorption. Thus the desorption control of the hydrogen tank 11 is started, the tank desorption control S10 is performed. The signal triggering the start of the hydrogen tank detachment is not particularly limited, and the user may operate the detachment start switch (not shown) provided, or the content of the hydrogen tank 11 is reduced, a signal may be emitted when the pressure falls below a predetermined pressure.

### 2.2.2. Closing of the Opening/Closing Valve

S12 the closing of the on-off valve, the control device 50 closes the on-off valve 15 and the push rods 24 in response to a closing signal received in the process S11. Specifically in the present embodiment, the control device 50 closes the valve body 16 and the push rod 24 by releasing the pressing of the valve body 16 by moving the push rod 24.

On the other hand, for the opening and closing of the supply pipe 22, when the structure for controlling and driving the hydrogen tank 11·on-off valve 15 side with the push rod side 24 fixed and pressing the valve body 16, the control device 50 moves the hydrogen tank 11·on-off valve 15 side instead of moving the push rod 24 to release the pressing of the valve body 16.

When a plurality of hydrogen tanks 11 are arranged performs this operation for all of the hydrogen tanks 11.

### 2.2.3. Calculation of the Amount of Hydrogen to be Consumed

In the process S13 of calculating the amount of hydrogen to be consumed, the pressure in the supply pipe 22 obtained from the pressure gauge 31, and from the capacity of the supply pipe 22, the pressure in the supply pipe 22 is less than 1 MPa to calculate the amount of hydrogen to be consumed to. This calculation may be based on theoretical values, or a relational expression or a map obtained by a test in advance may be used.

### 2.2.4. Determination of Amount of Hydrogen to be Consumed

In the process S14 for determining the amount of hydrogen to be consumed, it is determined whether the amount of hydrogen calculated in the process S13 is 0 or less. If the hydrogen content calculated by the process S13 is larger than 0, it is regarded as No and proceeds to process S15.

If the amount of hydrogen is 0 or less, since the pressure in the supply pipe 22 is considered to be less than 1 MPa, is a Yes, to terminate the desorption control S10 of the hydrogen tank. After completion of the desorption control, this is reported, and it is reported that the desorption of the hydrogen tank 11 may be performed.

Here, at the time of determination of the process S14, a return from the process S19, when already power generation by the fuel cell 21 is performed, the control device 50 is stopped injection 30 also performs together power generation is stopped.

It is to be noted that, by providing a locking mechanism (not shown) or the like, the hydrogen tank 11 may not be detached until the detachment control of the hydrogen tank 11 is completed, and in this case, the locking mechanism is released by the end of the detachment control.

### 2.2.5. Calculation of Fuel Cell Side Conditions

In the process S15 of calculating the fuel cell side conditions, when generating power in the fuel cell 21 in the subsequent process S16, to calculate the conditions to be satisfied in the fuel cell 21 side. Especially when the hydrogen supply to the fuel cell 21 is insufficient and a state of hydrogen deficiency, lowering of the voltage of the fuel cell, damage to the fuel cell 21, due to malfunctions in normal power generation, etc., to give a power generation condition for avoiding the deficiency state.

More specifically, the current request value of the fuel cell, and calculates a current upper limit value of the fuel cell. Here, the “current requirement value” is the value of the current required to consume the hydrogen quantity to be consumed calculated in the process S13 within a predetermined period of time. Further, the “current upper limit value” is an upper limit value of the current which can be guaranteed to prevent hydrogen deficiency from occurring.

Any value may be calculated by a theoretical value, or a relational expression or a map obtained by a test in advance may be used.

### 2.2.6. Generate Electricity According to the Conditions

In the process S16 for generating power according to the conditions, the control unit 50 actuates the injection 30, the hydrogen in the flow path of the supply pipe 22 is sent to the fuel cell 21 to generate power, consuming hydrogen in the flow path of the supply pipe 22.

Power generation at this time is performed by the current demand calculated by the process S15 described above.

Pressure in the pipe is consumed hydrogen in the flow path of the supply pipe 22 by this process S16 is reduced. Electricity obtained by the process S16 is not particularly limited, power supply to the electrical equipment, it can be used for charging or the like of the secondary batteries (not shown).

### 2.2.7. Determination of Whether the Upper Current Limit is Exceeded

In the process S17 of the determination of whether the current upper limit value is exceeded, it is determined whether the actual current value exceeds the current upper limit value calculated by the process S15.

The required current value calculated by the process S15 is a current value assuming an idealized state, the actual current may differ from the current required value due to the state of the fuel cell 21 such as deterioration of the fuel cell 21 and water accumulation or the like. Even if the actual current value is different from the current demand value, there is no problem if the current upper limit value calculated in the process S15 is not exceeded, but if the actual current value exceeds the current upper limit value, there is a possibility that the above-described problem of hydrogen deficiency occurs. Therefore, the process S17 determines whether the actual current value exceeds the current upper limit value. When the actual current value is less than the upper current limit value, it is No and the process S19 proceeds. On the other hand, if the actual current value exceeds the current upper limit value is Yes, the process proceeds to S18.

### 2.2.8. Change of Current Requirement

In the process S18 of changing the current request value, the current request value is changed so that when it is judged that the current exceeds the current upper limit value in the process S17, this is avoided (the actual current value is equal to or less than the current upper limit value). Therefore, in the process S18, the value corrected so as to lower the current requirement is calculated.

Then, the process returns to the process S16 so as to generate power based on the corrected current demand.

### 2.2.9. Determination Whether Pressure Conditions are Met

In the process S19 of the determination of whether the pressure condition is satisfied, it is determined whether the actual pressure in the feed pipe 22 is greater than the estimated pressure such that a hydrogen-depletion.

The pressure at which hydrogen deficiency occurs can be calculated as an estimate. Therefore, in the process S19, it is calculated whether the actual pressure in the feed pipe 22 is greater than the calculated estimate. The pressure in the actual supply pipe 22 can be obtained by the pressure gauge 31.

If the pressure in the actual feed pipe 22 exceeds the estimated value, it is considered that no hydrogen-deficiency has occurred, and therefore, the process S13 is returned to continue to be controlled.

On the other hand, when the pressure in the actual supply pipe 22 is equal to or less than the estimated value, terminates by stopping the control because there is a possibility that hydrogen depletion occurs. The color end above.

Incidentally, the pipe for the high pressure range in the feed pipe 22, but includes a pipe for the medium pressure range, it is preferable to apply the process S19 for any of the pipes. Thus, the effect of the present disclosure becomes more reliably remarkable.

### 3. Effect, etc.

According to the hydrogen consumption system described above, it is possible to suppress the generation of emission sound at the time of detachment of the hydrogen tank. At this time, it is possible to suppress the waste of hydrogen (fuel) to utilize the hydrogen remaining in the piping for power generation. On the other hand, generation of hydrogen deficiency in the fuel cell is also suppressed.

In the above embodiment, after stopping the hydrogen supply from the hydrogen tank, it is possible to perform the degassing process to a pressure insufficient hydrogen supply to the fuel cell is feared (less than 1 MPa), the hydrogen tank to suppress the emission sound during desorption. On the other hand, power generation can be continued by consuming hydrogen in the piping while avoiding hydrogen deficiency in the fuel cell by monitoring the current upper limit value of the fuel cell and monitoring the drop in the hydrogen pressure in the piping.

### REFERENCE SIGNS LIST

10 . . . Hydrogen consumption system, 11 . . . hydrogen tank, 15 . . . on-off valve, 16 . . . valving element, 17 . . . connection, 20 . . . consuming device, 21 . . . fuel cell, 22 . . . supply piping, 23 . . . connecting device, 24 . . . push rod (piping side on-off valve), 25 . . . connection, 30 . . . injection, 31 . . . pressure gauge, 50 . . . control device

What is claimed is:

1. A hydrogen consuming system comprising:
a detachable hydrogen tank;
a fuel cell using hydrogen from the hydrogen tank as a fuel;
piping connecting the hydrogen tank and the fuel cell, the hydrogen flowing through the piping,
an on-off valve provided with the piping; and
a control device, wherein
when the hydrogen tank is separated,
the control device closes the on-off valve, and calculates hydrogen consumption caused by generation of electricity by the fuel cell until pressure in the piping is lower than 1 MPa; calculates, from the hydrogen consumption, a required current value and an upper limit current value for the fuel cell; and if an actual current value is higher than the upper limit current value, changes the required current value to be at most the upper limit current value.

2. The hydrogen consuming system according to claim 1, wherein the control device compares an estimated pressure at which the fuel cell is deficient in hydrogen, and an actual pressure in the piping, and if the actual pressure is at most the estimated pressure, stops the generation of electricity by the fuel cell.
